(19) United States
(12) Patent Application Publication
(10) Pub. No.: US 2014/0215592 A1
(43) Pub. Date: Jul. 31, 2014

(54) METHOD, APPARATUS AND SYSTEM FOR USER AUTHENTICATION

(71) Applicant: TENCENT TECHNOLOGY (SHENZHEN) COMPANY LIMITED, Shenzhen (CN)

(72) Inventors: RONGHUI YANG, Shenzhen (CN); XING ZENG, Shenzhen (CN); ZHENZHEN JIANG, Shenzhen (CN); MOYE CHENG, Shenzhen (CN); XIAO GUO, Shenzhen (CN); ZHAO WANG, Shenzhen (CN)

(73) Assignee: TENCENT TECHNOLOGY (SHENZHEN) COMPANY LIMITED, Shenzhen (CN)

(21) Appl. No.: 14/201,868

(22) Filed: Mar. 9, 2014

Related U.S. Application Data
(63) Continuation of application No. PCT/CN2013/087208, filed on Nov. 15, 2013.

(30) Foreign Application Priority Data
Jan. 30, 2013 (CN) 201310035457.1

(51) Int. Cl. H04L 29/06

(52) U.S. Cl. CPC H04L 63/083
USPC 726/7

(57) ABSTRACT

A method is provided for user authentication. The method includes receiving an authentication request sent from a business system for authenticating a user, obtaining operation scenario information and operation basic elements, and displaying the operation scenario information and the operation basic elements. The method also includes receiving authentication information and the operation basic elements. Further, the method includes authenticating an identity of the user based on the received authentication information. The method includes obtaining an authentication result and sending the authentication result to the business system.

### CROSS-REFERENCES TO RELATED APPLICATIONS

This application is a continuation application of PCT Patent Application No. PCT/CN2013/087208, filed on Nov. 15, 2013, which claims priority of Chinese Patent Application No. 201310035457.1, filed on Jan. 30, 2013, the entire contents of all of which are incorporated by reference herein.

### FIELD OF THE INVENTION

The present invention generally relates to communication security technologies and, more particularly, to a method, apparatus and system for user authentication.

### BACKGROUND

With the development of technologies, especially with the rapid development of Internet technologies, composition of wealth and the way people interact with each other have changed dramatically, which include the change of wealth types and transaction methods. Nowadays, the boundary between virtual wealth and traditional wealth is becoming increasingly unclear. When managing and trading wealth, it has become more common for people to utilize non-traditional approaches. For example, people can make purchases, transfer money, and perform other financial operations through the Internet. Therefore, how to improve the security of user authentication has become a very important issue.

Currently, although there are many existing authentication methods to protect user data (i.e. user identity information and financial data), criminals still find ways to bypass the authentication process. One typical method is to trick users into entering correct authentication information through “phishing” and to obtain a certification that can be verified, thereby acquiring the users' operation privileges to perform illegal operations. For example, criminals may transfer a user's money out from the user's bank account. The existence of identity theft has a significantly negative impact on user data security.

To solve this problem, existing techniques generally use user-defined questions, static passwords, dynamic passwords, Short Message Service (SMS) verification codes and other methods to prevent phishing. However, these existing methods have their own limitations and may also encounter phishing attacks.

The disclosed method, apparatus and system are directed to solve one or more problems set forth above and other problems.

### BRIEF SUMMARY OF THE DISCLOSURE

One aspect of the present disclosure includes a method for user authentication. The method includes receiving an authentication request sent from a business system for authenticating a user, obtaining operation scenario information and operation basic elements, and displaying the operation scenario information and the operation basic elements. The method also includes receiving authentication information and the operation basic elements. Further, the method includes authenticating identity of the user based on the received authentication information, obtaining an authentication result and sending the authentication result to the business system.

Another aspect of the present disclosure includes an apparatus for user authentication. The apparatus includes an obtaining unit configured to receive an authentication request sent from a business system for authenticating a user and to obtain operation scenario information and operation basic elements. The apparatus also includes a display unit configured to display the operation scenario information and the operation basic elements. Further, the apparatus includes a receiving unit configured to receive authentication information sent and the operation basic elements. The apparatus includes an authentication unit configured to authenticate identity of the user based on the received authentication information and to prompt the operation scenario information and the operation basic elements during the authentication process and a sending unit configured to send an authentication result to the business system.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow chart of an exemplary authentication process performed on an authentication apparatus consistent with the disclosed embodiments;

FIG. 2 illustrates a flow chart of another exemplary authentication process performed on an authentication apparatus consistent with the disclosed embodiments;

FIG. 3 illustrates a structure diagram of an exemplary authentication apparatus consistent with the disclosed embodiments;

FIG. 4 shows an environment incorporating certain aspects of the present invention; and

FIG. 5 shows a block diagram of an exemplary computing system according to the disclosed embodiments.

### DETAILED DESCRIPTION

Reference will now be made in detail to exemplary embodiments of the invention, which are illustrated in the accompanying drawings.

FIG. 4 illustrates an exemplary environment 400 incorporating certain disclosed embodiments. As shown in FIG. 4, environment 400 may include a terminal 404, a server 406, and the Internet 402. The terminal 404 may access the server 406 through the Internet 402 for certain personalized services provided by the server 406. Although only one server 406 and one terminal 404 is shown in the environment 400, any number of terminals 404 or servers 406 may be included, and other devices may also be included.

The Internet 402 may include any appropriate type of communication network for providing network connections to the terminal 404 and server 406 or among multiple terminals 404 and servers 406. For example, Internet 402 may include the Internet or other types of computer networks or telecommunication networks, either wired or wireless.

A terminal, as used herein, may refer to any appropriate user terminal with certain computing capabilities, such as a personal computer (PC), a work station computer, a server computer, a hand-held computing device (tablet), a smart phone or mobile phone, or any other user-side computing device. In certain embodiments, terminal 404 may be a wireless terminal, such as a smart phone, a tablet computer, or a mobile phone, etc.

A server, as used herein, may refer one or more server computers configured to provide certain web server functionalities to provide certain personalized services, which may require any user accessing the services to authenticate to the website before the access. A server may also include one or more processors to execute computer programs in parallel.

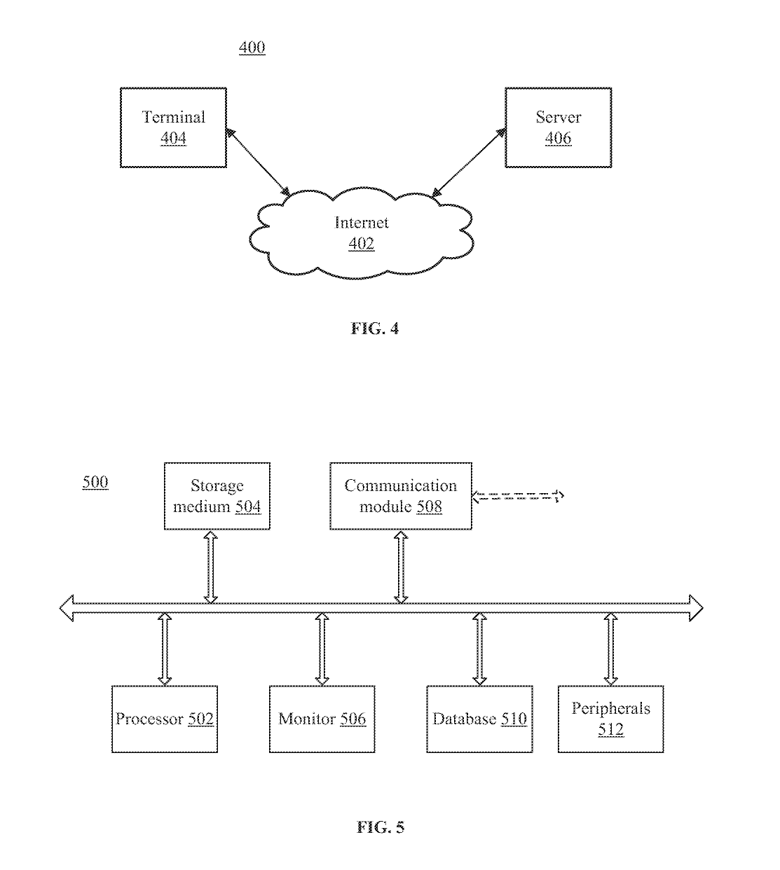

Terminal 404 and/or server 406 may be implemented on any appropriate computing platform. FIG. 5 shows a block diagram of an exemplary computer system 500 capable of implementing terminal 404.

As shown in FIG. 5, computer system 500 may include a processor 502, a storage medium 504, a monitor 506, a communication module 508, a database 510, and peripherals 512. Certain devices may be omitted and other devices may be included.

Processor 502 may include any appropriate processor or processors. Further, processor 502 can include multiple cores for multi-thread or parallel processing. Storage medium 504 may include memory modules, such as ROM, RAM, flash memory modules, and erasable and rewritable memory, and mass storages, such as CD-ROM, U-disk, and hard disk, etc. Storage medium 504 may store computer programs for implementing various processes, when executed by processor 502.

Further, peripherals 512 may include I/O devices such as keyboard and mouse, and communication module 508 may include network devices for establishing connections through the communication network. Database 510 may include one or more databases for storing certain data and for performing certain operations on the stored data, such as database searching.

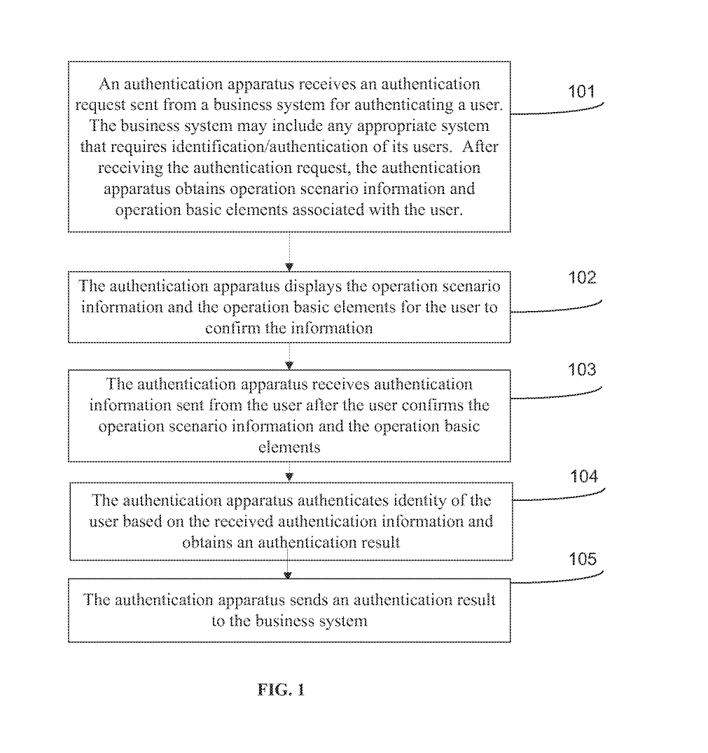

In operation, terminal 404 may run a web browser and perform certain Internet accessing for personalized services. That is, server 406 and/or terminal 404 may perform certain user authentication processes to facilitate the access to various services. Any appropriate user authentication may be included. FIG. 1 illustrates a flow chart of an exemplary authentication process performed on an authentication apparatus consistent with the disclosed embodiments.

As shown in FIG. 1, the authentication process includes the following steps.

Step 101: an authentication apparatus receives an authentication request sent from a business system for authenticating a user. The business system may include any appropriate system that requires identification/authentication of its users. After receiving the authentication request, the authentication apparatus obtains operation scenario information and operation basic elements associated with the user.

The authentication apparatus may obtain the operation scenario information and the operation basic elements through many different ways. The details of Step 101 are as follows: the authentication apparatus receives the authentication request sent from the business system and obtains the operation scenario information and the operation basic elements from the business system based on the authentication request, or the authentication apparatus receives the authentication request which carries the operation scenario information and the operation basic elements from the business system.

Specifically, the authentication apparatus may be an authentication server. The business system may be a business server. The operation scenario information may include an operation name and/or operation status under the current operation scenario, which is used to inform the user the current operation status. The operation basic elements are mainly used to help the user determine whether an operation is initiated by him/her.

For example, basic elements of an account transfer operation may include a transfer amount, a target object information, etc.; basic elements of a payment operation include a payment amount, shopping goods, a recipient, a shipping address, etc. Similarly, operations in a virtual world such as online games may also include multiple basic elements, which are not repeated here.

Step 102: the authentication apparatus displays the operation scenario information and the operation basic elements obtained from Step 101 for the user to confirm the information.

For example, the authentication interface displays the operation scenario information and the operation basic elements and requests the user to confirm the information. If the user confirms that the operation scenario information and the operation basic elements are the same as the scenario information and the operation basic elements that he/she has initiated, Step 103 is performed; otherwise, it indicates that there may be phishing activity, the process is ended or the authentication apparatus alerts the user that there is phishing activity and asks the user to select the next step.

Step 103: the authentication apparatus receives authentication information sent from the user after the user confirms the operation scenario information and the operation basic elements.

For example, the authentication apparatus may receive an account number, a password and/or a verification code sent from the user.

Step 104: the authentication apparatus authenticates identity of the user based on the received authentication information and obtains an authentication result.

Further, during the authentication process, if there is a step that needs to authentication of the user, the authentication apparatus may again prompt the user with operation scenario information and operation basic elements related to this step.

Specifically, when the authentication apparatus sends out a mobile phone verification code to the user, the authentication apparatus may prompt the user with the operation scenario information and the operation basic elements associated with sending mobile phone verification codes.

When the authentication apparatus displays a machine verification code on an interface, the authentication apparatus may prompt the user with the operation scenario information and the operation basic elements associated with providing machine verification codes on the display interface.

When the authentication apparatus requests the user to enter a password, the authentication apparatus may prompt the user with the operation scenario information and the operation basic elements associated with requesting the user to enter the password.

When the authentication apparatus requests the user to confirm entered information, the authentication apparatus may prompt the user with the operation scenario information and the operation basic elements associated with requesting the user to confirm the entered information.

Of course, other steps may also require the operation scenario information and the operation basic elements to be prompted to the user, which are omitted here.

Further, there may be many different ways to prompt the user with the operation scenario information and the operation basic elements. For example, the operation scenario information and the operation basic elements may be prompted to the user through a pop-up window, or the operation scenario information and the operation basic elements may be carried in a message and sent to the user.

Step 105: the authentication apparatus sends an authentication result to the business system.

If the authentication apparatus determines that the identity of the user is legal, the authentication apparatus sends an authentication result that the authentication is successful to the business system; if the authentication apparatus determines that the identity of the user is illegal, the authentication apparatus sends an authentication result that the authentication is unsuccessful to the business system.

After the business system receives the authentication result, if the authentication is successful, the business system allows the user to perform the operation; if the authentication is unsuccessful, the business system does not allow the user to perform the operation.

Thus, an authentication apparatus receives an authentication request sent from a business system for authenticating a user. After receiving an authentication request, the authentication apparatus obtains operation scenario information and operation basic elements associated with the user, and displays the operation scenario information and the operation basic elements for the user to confirm the information. The authentication apparatus receives the authentication information sent from the user after the user confirms the operation scenario information and the operation basic elements. Then, the authentication apparatus authenticates identity of the user based on the received authentication information and again prompts the user with the operation scenario information and the operation basic elements during the authentication process, as well as sends an authentication result to the business system. The authentication process can alert the user and help the user identify phishing attacks, thereby preventing phishing attacks, improving the effectiveness of authentication, as well as improving the security of user data.

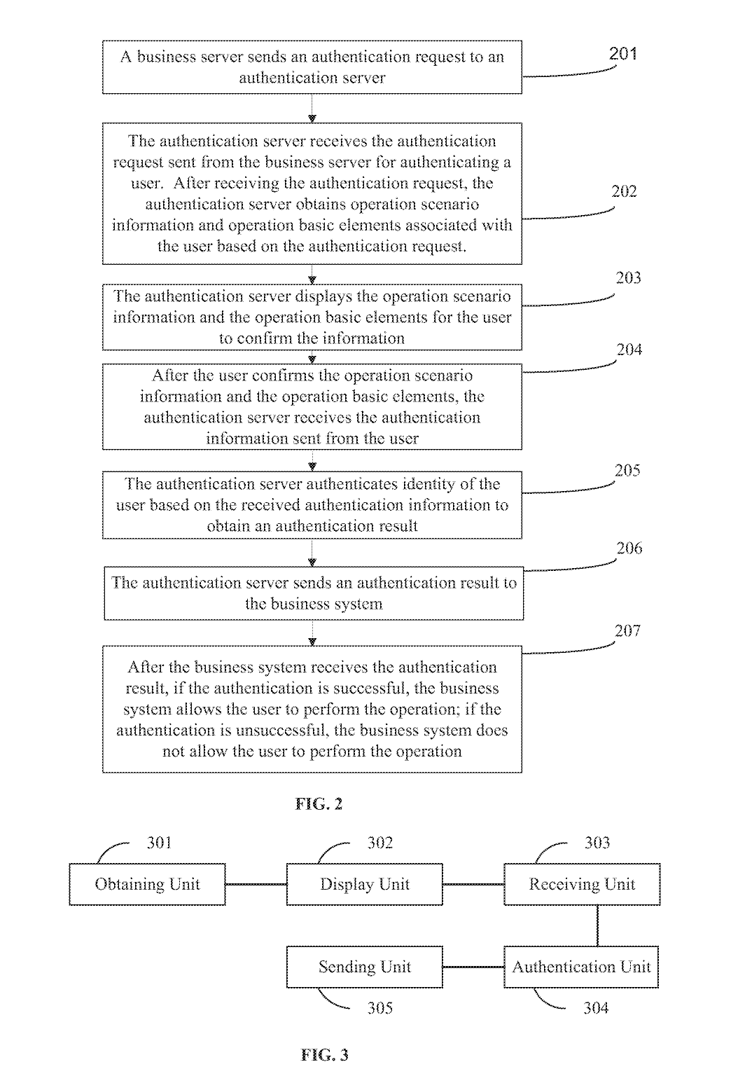

FIG. 2 illustrates a flow chart of another exemplary authentication process performed on an authentication apparatus consistent with the disclosed embodiments. As used herein, the authentication apparatus may be an authentication server, and the business system may be a business server. As shown in FIG. 2, the authentication process includes the following steps.

Step 201: a business server sends an authentication request to an authentication server.

The business server may include any appropriate server that requires identification/authentication of its users.

Step 202: the authentication server receives the authentication request sent from the business server for authenticating a user. After receiving the authentication request, the authentication server obtains operation scenario information and operation basic elements associated with the user based on the authentication request.

The operation scenario information is mainly used to timely inform a user current operation status, which may include an operation name and/or operation status under the current operation scenario. The operation basic elements are mainly used to help the user determine whether an operation is really initiated by him/her.

For example, for a transfer account operation, its operation name can be “transfer”, and its operation status can be the current transfer account progress or status, such as “to be transferred” or “transfer in progress”. The basic elements of the transfer account operation may include transfer amount, a target object, etc.

For another example, for a payment operation, its operation name can be “payment”, and its operation status can be the current payment progress or status, such as “to be paid” or “payment in progress”. The basic elements of the payment operation may include a payment amount, shopping goods, a recipient, a shipping address, etc. Other operations are also similar, which are not repeated here.

It should be noted that, when the business server sends an authentication request to the authentication server, the business server may also provide the authentication request which carries the operation scenario information and the operation basic elements for the authentication server. The implementation is similar, which is not repeated here.

Step 203: the authentication server displays the operation scenario information and the operation basic elements for the user to confirm the information.

For example, an authentication interface displays the operation scenario information and the operation basic elements and requests the user to confirm the information. If the user confirms that the operation scenario information and the operation basic elements are the same as the scenario information and the operation basic elements that he/she has initiated, the process goes to Step 204; otherwise, it indicates that there may be phishing activity, the process is ended or the authentication server alerts the user that there is phishing activity and asks the user to select the next step.

Step 204: after the user confirms the operation scenario information and the operation basic elements, the authentication server receives the authentication information sent from the user.

For example, the authentication server may receive an account number, a password and/or a verification code sent from the user.

Step 205: the authentication server authenticates identity of the user based on the received authentication information to obtain an authentication result.

During the authentication process, if there is any step that needs to obtain the certification or authentication, the authentication server may again prompt the user with the operation scenario information and the operation basic elements which relate to this step.

For example, the authentication server can prompt the user with operation scenario information and operation basic elements when sending a mobile phone verification code. There are many different ways to prompt the user with the operation scenario information and the operation basic elements. The operation scenario information and the operation basic elements may be carried in a verification code message and sent to the user, or the operation scenario information and the operation basic elements may be prompted to the user through a pop-up window.

For another example, the operation scenario information and the operation basic elements may be again displayed on an authentication interface for the user to confirm when a machine verification code is displayed on the authentication interface. For an account transfer operation, the authentication interface can remind the user that the transfer operation is ongoing and display the amount to be transferred, a target object, etc. Therefore, the user can determine whether the current operation is the same as the operation that he/she has initiated. If it is determined that the current operation is different from the operation that he/she has initiated, it indicates that there may be a phishing attack. The user may terminate the operation. The operation scenario information and the operation basic elements can be displayed with the verification code on the same interface or be prompted to the user through a pop-up window.

For another example, the operation scenario information and the operation basic elements can be prompted to the user when requesting the user to enter a password and/or requesting the user to confirm the entered information. For a payment operation, the current operation status is displayed to the user to prompt the user that a payment is in progress, and a payment amount, shopping goods, a recipient and a shipping address are also displayed for the user to confirm again. If the user confirms that all information is the same as the operation that he/she has initiated, it indicates that the current payment is safe. Otherwise, it indicates that there may be a phishing attack. The user can prevent the phishing attack by terminating the current operation. The operation scenario information and the operation basic elements can be displayed with the verification code on the same interface or be prompted to the user through a pop-up window.

In addition to above described steps, the operation scenario information and the operation basic elements can be prompted to the user in other steps, which are not repeated here.

Step 206: the authentication server sends an authentication result to the business system.

If the authentication server determines that the identity of the user is legal, the authentication server sends the authentication result that the authentication is successful to the business system; if the authentication server determines that the identity of the user is illegal, the authentication server sends the authentication result that the authentication is unsuccessful to the business system.

Step 207: after the business system receives the authentication result, if the authentication is successful, the business system allows the user to perform the operation; if the authentication is unsuccessful, the business system does not allow the user to perform the operation.

Thus, a business server sends an authentication request to an authentication server. The authentication server receives the authentication request sent from the business server for authenticating a user. After receiving the authentication request, the authentication server obtains operation scenario information and operation basic elements associated with the user based on the authentication request, and displays the operation scenario information and the operation basic elements for the user to confirm the information. The authentication server receives the authentication information sent from the user after the user confirms the operation scenario information and the operation basic elements. Then, during the authentication process, the authentication server again prompts the user with the operation scenario information and the operation basic elements. The authentication process can alert the user and help the user identify phishing attacks, thereby preventing phishing attacks, improving the effectiveness of authentication, as well as improving the security of user data.

Accordingly, an authentication apparatus is provided. FIG. 3 illustrates a structure diagram of an exemplary authentication apparatus consistent with the disclosed embodiment. As shown in FIG. 3, the authentication apparatus includes an obtaining unit 301, a display unit 302, a receiving unit 303, an authentication unit 304 and a sending unit 305.

The obtaining unit 301 is configured to obtain operation scenario information and operation basic elements associated with the user after receiving an authentication request sent from a business system for authenticating a user.

Specifically, the business system may be a business server. The operation scenario information is mainly used to timely inform a user the current operation status, which may include an operation name and/or operation status under the current operation scenario. The operation basic elements are mainly used to help the user determine whether an operation is really initiated by him/her.

For example, basic elements of a transfer account operation may include a transfer amount, a target object, etc. While basic elements of a payment operation may include a payment amount, shopping goods, a recipient, a shipping address, etc. Similarly, operations in a virtual world (such as operations of online games) may also include a variety of basic elements, which are not repeated here.

The display unit 302 is configured to display the operation scenario information and the operation basic elements for the user to confirm the information.

The receiving unit 303 is configured to receive authentication information sent from the user after the user confirms the operation scenario information and the operation basic elements.

Specifically, the authentication information may include an account number, a password and/or a verification code, and so on.

The authentication unit 304 is configured to authenticate identity of the user based on the received authentication information, and to prompt the user with the operation scenario information and the operation basic elements during the authentication process.

The sending unit 305 is configured to send an authentication result to the business system.

For example, if the authentication unit 304 determines that the identity of the user is legal, the sending unit 305 may send an authentication result that the authentication is successful to the business system; if the authentication unit 304 determines that the identity of the user is illegal, the sending unit 305 may send an authentication result that the authentication is unsuccessful to the business system.

The obtaining unit 301 may obtain the operation scenario information and the operation basic elements associated with the user through various methods. The details are noted below.

The obtaining unit 301 is further configured to obtain the operation scenario information and the operation basic elements associated with the user based on the authentication request after receiving an authentication request sent from the business system for authenticating the user, or the obtaining unit 301 is further configured to receive an authentication request sent from the business system for authenticating the user, where the authentication request carries the operation scenario information and the operation basic elements associated with the user.

The authentication unit 304 is configured, when sending out a mobile phone verification code, to prompt the user with the operation scenario information and the operation basic elements associated with sending mobile phone verification codes; the authentication unit 304 is configured, when displaying a machine verification code in an interface, to prompt the user with the operation scenario information and the operation basic elements associated with providing machine verification codes on the display interface; the authentication unit 304 is configured, when prompting the user to enter a password, to prompt the user with the operation scenario information and the operation basic elements associated with requesting the user to enter the password; the authentication unit 304 is configured, when prompting the user to confirm the entered information, to prompt the user with the operation scenario information and the operation basic elements associated with requesting the user to confirm the entered information.

In addition to the above described steps, the authentication unit 304 may also prompt the user with the operation scenario information and the operation basic elements in other steps, which are omitted here.

Furthermore, there are many different ways to prompt the user with the operation scenario information and the operation basic elements associated with the user. For example, the operation scenario information and the operation basic elements may be prompted to a user through a pop-up window, or the operation scenario information and the operation basic elements may be carried in a message and sent to the user, and so on. That is, the authentication unit 304 is configured to prompt the user with the operation scenario information and the operation basic elements through the pop-up window or through a message which carries the operation scenario information and the operation basic elements associated with the user.

The authentication apparatus may be an authentication server. In the specific implementations, the above each unit may be used as a separate entity or be combined as one or several entities. The specific implementations of the above units may be seen from the disclosed embodiments above, which are not repeated here.

As can be seen from the above described authentication apparatus, the obtaining unit 301 obtains operation scenario information and operation basic elements associated with the user after receiving an authentication request sent from a business server for authenticating a user. The display unit displays the operation scenario information and the operation basic elements for the user to confirm the information. The receiving unit 303 receives authentication information sent from the user after the user confirms the operation scenario information and the operation basic elements. Then, the authentication unit 304 authenticates identity of the user based on the received authentication information and prompts the user with the operation scenario information and the operation basic elements during the authentication process. The authentication apparatus can alert the user and help the user identify phishing attacks, thereby preventing phishing attacks, improving the effectiveness of the authentication, as well as improving the security of user data.

Accordingly, a communication system for user authentication is provided. The communication system includes a business system and an authentication apparatus consistent with the disclosed embodiments. The authentication apparatus is described in the above embodiments. The details are noted below.

The business system is configured to send an authentication request to the authentication apparatus and provide operation scenario information and operation basic elements for the authentication apparatus, as well as receive an authentication result sent from the authentication apparatus.

After receiving an authentication request from the business system, the authentication apparatus obtains operation scenario information and operation basic elements associated with the user, and displays the operation scenario information and the operation basic elements for the user to confirm the information. The authentication apparatus receives the authentication information sent from the user after the user confirms the operation scenario information and the operation basic elements. Then, the authentication apparatus authenticates identity of the user based on the received authentication information and prompts the user with the operation scenario information and the operation basic elements during the authentication process, as well as sends an authentication result to the business system.

The authentication apparatus may obtain the operation scenario information and the operation basic elements associated with the user through various methods. The details are as followings: the authentication apparatus is further configured to obtain the operation scenario information and the operation basic elements from the business system based on the authentication request when receiving an authentication request sent from the business system, or the authentication apparatus is further configured to receive an authentication request sent from the business system, where the authentication request carries the operation scenario information and the operation basic elements.

Specifically, the operation scenario information may include an operation name and/or operation status under the current operation scenario. The operation basic elements are mainly used to help the user determine whether an operation is really initiated by him/her.

For example, basic elements of a transfer account operation may include a transfer amount, a target object, etc. While basic elements of a payment operation may include a payment amount, shopping goods, a recipient, a shipping address, etc. Similarly, operations in a virtual world (such as operations of online games) may also include a variety of basic elements, which are not repeated here.

Specifically, when the authentication apparatus sends out a mobile phone verification code to the user, the authentication apparatus may prompt the user with the operation scenario information and the operation basic elements associated with sending mobile phone verification codes.

When the authentication apparatus displays a machine verification code on an interface, the authentication apparatus may prompt the user with the operation scenario information and the operation basic elements associated with providing machine verification codes on the display interface.

When the authentication apparatus requests the user to enter a password, the authentication apparatus may prompt the user with the operation scenario information and the operation basic elements associated with requesting the user to enter the password.

When the authentication apparatus requests the user to confirm entered information, the authentication apparatus may prompt the user with the operation scenario information and the operation basic elements associated with requesting the user to confirm the entered information.

There are many different ways to prompt the user with the operation scenario information and the operation basic elements associated with the user, such as the operation scenario information and the operation basic elements may be prompted to the user through a pop-up window, or the operation scenario information and the operation basic elements may be carried in a message and sent to the user.

Specially, the authentication apparatus may be an authentication server, and the business system may be a business server.

Thus, the authentication apparatus of the authentication system obtains operation scenario information and operation basic elements from a business system after receiving an authentication request for authenticating a user, and displays the operation scenario information and the operation basic elements for the user to confirm the information. The authentication apparatus receives the authentication information sent from the user after the user confirms the operation scenario information and the operation basic elements. Then, during the authentication process, the authentication apparatus again prompts the user with the operation scenario information and the operation basic elements. The authentication process can alert the user and help the user identify phishing attacks, thereby preventing phishing attacks, improving the effectiveness of authentication, as well as improving the security of user data.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed method, apparatus and system for user authentication, an authentication apparatus receives an authentication request sent from a business system for authenticating a user. After receiving an authentication request, the authentication apparatus obtains operation scenario information and operation basic elements associated with the user, and displays the operation scenario information and the operation basic elements for the user to confirm the information. The authentication apparatus receives the authentication information sent from the user after the user confirms the operation scenario information and the operation basic elements. Then, the authentication apparatus authenticates identity of the user based on the received authentication information and again prompts the user with the operation scenario information and the operation basic elements during the authentication process, as well as sends an authentication result to the business system. The authentication process can alert the user and help the user identify phishing attacks, thereby preventing phishing attacks, improving the effectiveness of authentication, as well as improving the security of user data.

What is claimed is:

1. A method for user authentication, comprising:
receiving, by an authentication apparatus, an authentication request sent from a business system for authenticating a user;
obtaining, by an authentication apparatus, operation scenario information and operation basic elements;
displaying, by the authentication apparatus, the operation scenario information and the operation basic elements;
receiving, by the authentication apparatus, authentication information;
authenticating, by the authentication apparatus, an identity of the user based on the received authentication information;
obtaining, by the authentication apparatus, an authentication result; and
sending, by the authentication apparatus, the authentication result to the business system.

2. The method according to claim 1, wherein obtaining operation scenario information and operation basic elements further includes:
obtaining the operation scenario information and the operation basic elements from the business system based on the authentication request; or
receiving the authentication request which carries the operation scenario information and the operation basic elements from the business system.

3. The method according to claim 2, wherein:
the operation scenario information includes an operation name and an operation status under a current operation scenario.

4. The method according to claim 2, wherein:
the operation scenario information timely informs the user a current operation status; and
the operation basic elements help the user determine whether an operation is initiated by the user.

5. The method according to claim 1, wherein authenticating an identity of the user based on the received authentication information further includes:
prompting the user again with the operation scenario information and the operation basic elements during the authentication process.

6. The method according to claim 5, wherein prompting the user with the operation scenario information and the operation basic elements during the authentication process further includes:
when sending out a mobile phone verification code to the user, prompting the user with the operation scenario information and the operation basic elements associated with sending mobile phone verification codes;
when displaying a machine verification code on an interface, prompting the user with the operation scenario information and the operation basic elements associated with providing machine verification codes on the display interface;
when requesting the user to enter a password, prompting the user with the operation scenario information and the operation basic elements associated with requesting the user to enter the password; and
when requesting the user to confirm entered information, prompting the user with the operation scenario information and the operation basic elements associated with requesting the user to confirm the entered information.

7. The method according to claim 6, wherein prompting the user with the operation scenario information and the operation basic elements further includes:
prompting the user the operation scenario information and the operation basic elements through a pop-up window; and
sending a verification message which carries the operation scenario information and the operation basic elements to the user.

8. The method according to claim 1, wherein sending the authentication result to the business system further includes:
sending the authentication result that the authentication is successful to the business system when the authentication server determines that identity of the user is legal; and
sending the authentication result that the authentication is unsuccessful to the business system when the authentication server determines that identity of the user is illegal.

9. The method according to claim 1, after sending the authentication result to the business system, further including:
allowing, by the business system, the user to perform the operation when the business system receives the authentication result that the authentication is successful; and
denying, by the business system, the user to perform the operation when the business system receives the authentication result that the authentication is unsuccessful.

10. An apparatus for user authentication, comprising:
an obtaining unit configured to receive an authentication request sent from a business system for authenticating a user and to obtain operation scenario information and operation basic elements;
a display unit configured to display the operation scenario information and the operation basic elements;
a receiving unit configured to receive authentication information and the operation basic elements;
an authentication unit configured to authenticate an identity of the user based on the received authentication information and to prompt the operation scenario information and the operation basic elements during the authentication process; and
a sending unit configured to send an authentication result to the business system.

11. The apparatus according to claim 10, wherein the obtaining unit is further configured to:
obtain the operation scenario information and the operation basic elements from the business system based on the authentication request after receiving the authentication request sent from the business system; or
receive the authentication request sent from the business system, wherein the authentication request carries the operation scenario information and the operation basic elements.

12. The apparatus according to claim 10, wherein:
the operation scenario information includes an operation name and operation status under a current operation scenario.

13. The apparatus according to claim 11, wherein:
the operation scenario information timely informs a user a current operation status; and
the operation basic elements help the user determine whether an operation is initiated by the user.

14. The apparatus according to claim 10, wherein the authentication unit is further configured to:
prompt the user with the operation scenario information and the operation basic elements associated with sending mobile phone verification codes when sending out a mobile phone verification code to the user;
prompt the user with the operation scenario information and the operation basic elements associated with providing machine verification codes on the display interface when displaying a machine verification code on an interface;
prompt the user with the operation scenario information and the operation basic elements associated with requesting the user to enter the password when requesting the user to enter a password; and
prompt the user with the operation scenario information and the operation basic elements associated with requesting the user to confirm the entered information when requesting the user to confirm entered information.

15. The apparatus according to claim 14, wherein:
the authentication unit prompts the user the operation scenario information and the operation basic elements through a pop-up window; and
the authentication unit sends a verification message which carries the operation scenario information and the operation basic elements to the user.

16. The apparatus according to claim 10, wherein the sending unit is further configured to:
send the authentication result that the authentication is successful to the business system when the authentication unit determines that the identity of the user is legal; and
send the authentication result that the authentication is unsuccessful to the business system when the authentication unit determines that the identity of the user is illegal.

17. A communication system having a business system and an authentication apparatus according to claim 16, wherein:
the business system is configured to send an authentication request to an authentication apparatus and to provide operation scenario information and operation basic elements for the authentication apparatus, and to receive an authentication result sent from the authentication apparatus.

18. The system according to claim 17, wherein:
the business system allows the user to perform the operation when the business system receives the authentication result that the authentication is successful; and
the business system denies the user to perform the operation when the business system receives the authentication result that the authentication is unsuccessful.
